(19) United States
(12) Patent Application Publication
(10) Pub. No.: US 2004/0222680 A1
(43) Pub. Date: Nov. 11, 2004

(54) Inflatable seat restraint cushion

(75) Inventors: Werner Freisler, Aalen (DE); Gerd Zischka, Schwaebisch Gmuend (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive GmbH

(21) Appl. No.: 10/838,381

(22) Filed: May 4, 2004

(30) Foreign Application Priority Data
May 9, 2003 (DE) 103 20 967.0

(51) Int. Cl. B60R 21/26

(52) U.S. Cl. 297/219.1

(57) ABSTRACT

An inflatable seat restraint cushion has a plastically deformable support structure and a sealing casing. The sealing casing can be filled with gas from a compressed gas source in order to inflate the seat restraint cushion with deformation of the support structure.

The invention relates to an inflatable seat restraint cushion with a plastically deformable support structure, and a vehicle seat with such a seat restraint cushion.

### BACKGROUND OF THE INVENTION

In the US 2002/0190548 A1 a vehicle seat is described with a seat restraint cushion, which in the case of restraint is intended to prevent a vehicle occupant from slipping through under the pelvic belt. A support structure in the form of a plastically deformable plate arranged under the seat pad and connected with a closed seat frame part, forms a chamber which can be inflated in order to raise the seat pad in the front region. In order to be able to inflate the chamber, the support structure must be connected with the closed seat frame part in a gas-tight manner.

The invention provides a light seat restraint cushion which is able to be produced at a favourable cost.

### BRIEF DESCRIPTION OF THE INVENTION

For this purpose, in an inflatable seat restraint cushion of the type initially mentioned, a sealing casing is provided which can be filled with gas from a compressed gas source in order to inflate the seat restraint cushion with deformation of the support structure. The sealing casing produces a chamber, closed off in a gas-tight manner, in the seat restraint cushion for the volume of gas with which the seat restraint cushion is inflated. Thereby, the need is eliminated for the support structure to be closed or to be connected in a gas-tight manner with the seat restraint cushion in order to itself form an inflatable chamber. The support structure can thereby be constructed very simply and can assume any desired optimum shape for an optimum energy absorption with the plastic deformation by the vehicle occupant.

According to a further aspect, the invention also provides a vehicle seat with a seat pad and with such a seat cushion. As a result of the great freedom in design of the support structure, the seat cushion can be constructed so that it extends over the entire width of the seat and thereby offers the vehicle occupant a reliable protection against slipping through.

Further advantageous embodiments will be apparent from the sub-claims.

### BRIEF DESCRIPTION OF THE DRAWINGS

The invention is described in greater detail below with the aid of preferred embodiments. For this, reference is made to the enclosed drawings, in which:

FIG. 1 shows a cross-section through a vehicle seat with a seat restraint cushion according to a first embodiment of the invention;

FIG. 2 shows a view of the seat restraint cushion of FIG. 1 in a first state;

FIG. 3 shows a cross-section through the seat restraint cushion of FIG. 2 along the line III-III in FIG. 2;

FIG. 4 shows a view of the seat restraint cushion of FIG. 2 in a second state;

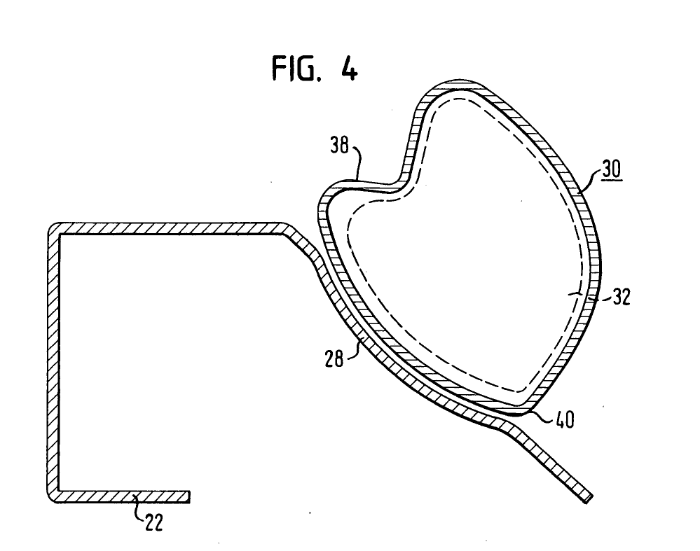

FIG. 5 shows the seat restraint cushion of FIG. 2 in a third state;

FIG. 6 shows a seat restraint cushion according to a second embodiment of the invention; and

FIG. 7 shows a cross-section through the seat restraint cushion of FIG. 6 along the line VII-VII in FIG. 6.

### DETAILED DESCRIPTION OF THE INVENTION

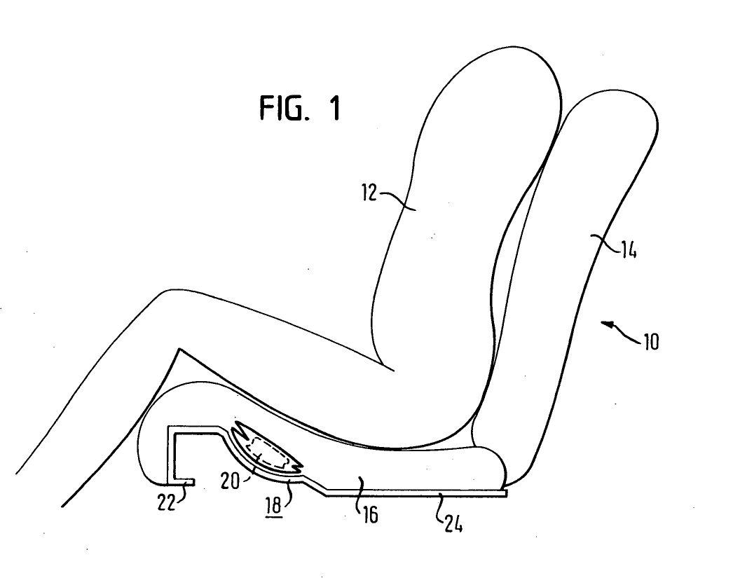

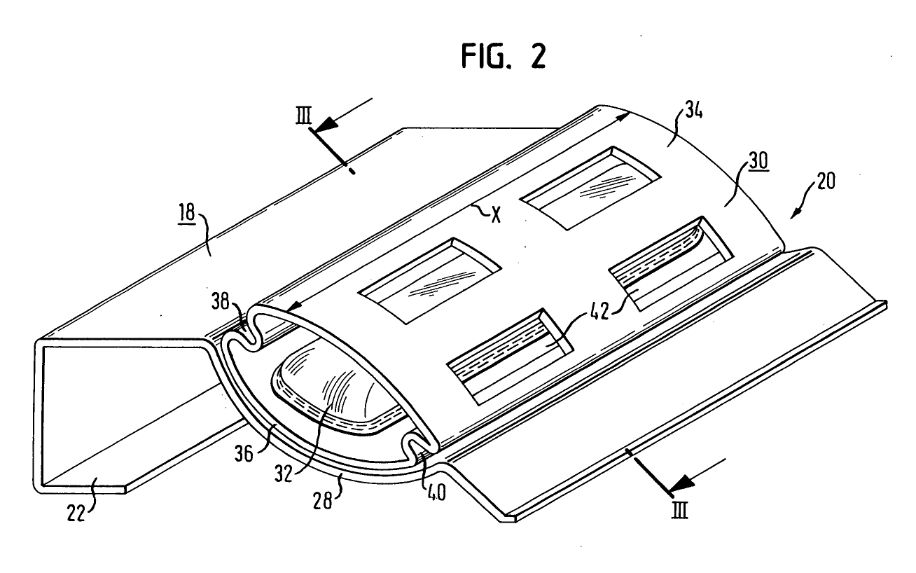

In FIG. 1 a vehicle seat 10 can be seen, in which an occupant 12 sits. The vehicle seat 10 has a back rest 14 and a seat pad 16, which is carried by a seat frame 18. Between the seat frame 18 and the seat pad 16 is an inflatable seat restraint cushion 20, which is illustrated in greater detail in FIG. 2.

The seat frame 18 has a frame strut 22 and a seat surface section 24, the frame strut 22 defining the front end of the seat frame 18 and the seat surface section extending backwards up to the back rest 14. Between the seat surface section 24 and the frame strut 22, the seat frame 18 forms a ramp 26, which runs rising to the front towards the frame strut 22. In the ramp 26 a trough 28 is formed, which extends parallel to the frame strut 22 transversely over the seat frame 18.

As can be seen clearly in FIG. 2, the seat restraint cushion 20 consists of a support structure 30, in which a gas bag 32 is housed. The support structure 30 has an upper shell 34 and a lower shell 36, which are connected by a front deformation element 38 and a rear deformation element 40. The two deformation elements 38 and 40 are folded, so that the support structure 30 rests flat on the seat frame 18 and in its interior offers just as much space that it is able to receive the empty gas bag 32. Therefore, the non-inflated seat restraint cushion 20 only has a small volume and, hidden in the trough 28, is not noticeable under the seat pad 16, so that the sitting comfort of the vehicle occupant 12 is not impaired.

The gas bag 32 forms a sealing casing and offers a simple possibility for providing a gas-tight inflatable chamber under the seat pad 16. The support structure 30 provides for a uniform load distribution onto the gas bag 32, which can thereby receive a higher overall load.

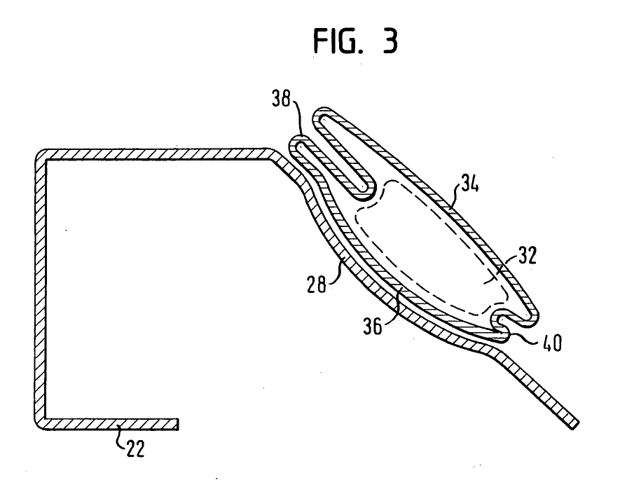

In the case of restraint, the seat restraint cushion 20 is inflated, by the gas abg 32 being filled with gas from a compressed gas source. In so doing, the support structure 30 is deformed in a plastic manner, by the deformation elements 38 and 40 being unfolded. As can be clearly seen in FIG. 3, the loop formed with the folding of the front deformation element 38 is greater than that of the rear deformation element 36. Thereby, this advantageously results in that the upper shell carries out a rearwardly directed swiveling movement on inflation of the seat restraint cushion 20, whereby a rearwardly acting force additionally contributes to protecting the vehicle occupant 12 from slipping through on the vehicle seat 10.

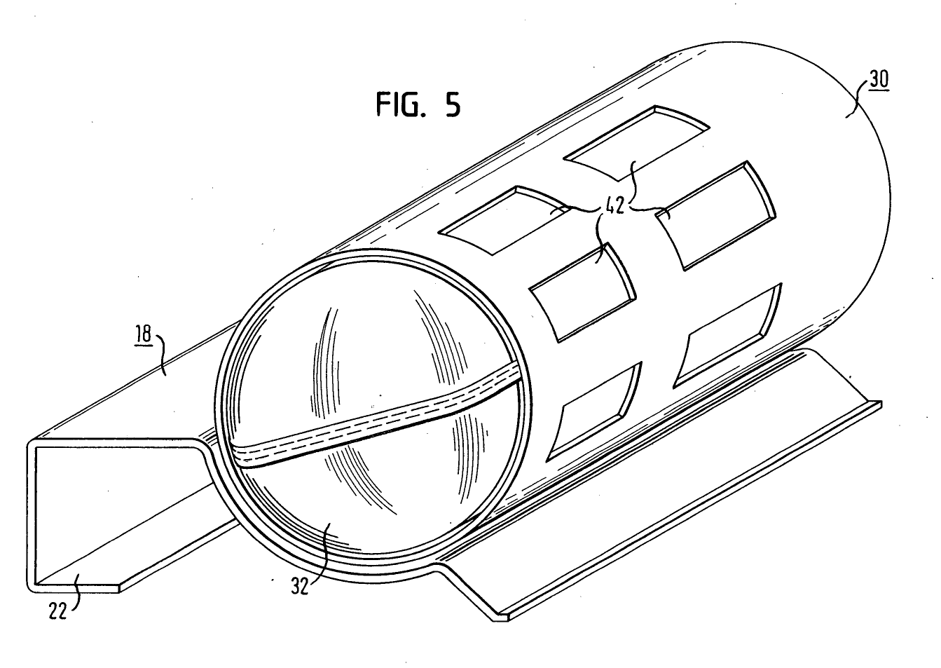

With a fully inflated seat restraint cushion 20, as can be seen in FIG. 5, the front edge of the seat pad 16 is raised sharply, so that the vehicle occupant 12 can be reliably restrained. In the case of restraint, the vehicle occupant 12 brings it about through the mass moment of inertia of his body that the support structure 30 is compressed, with the deformation elements 38 and 40 in particular deforming in a plastic manner and in so doing receiving energy from the vehicle occupant.

As only the gas bag 32, but not the support structure 30, has to be impervious, the latter can be constructed as desired, as is optimal for energy absorption. In the embodiment shown, the support structure 30 is advantageously formed by a sheet metal tube with open end faces, in which a uniform material thickness can be ensured over the entire length of the tube. Therefore, the seat restraint cushion 20 can fulfil its restraining function over the entire width X of the vehicle seat 10.

To save weight, the support structure 30 is provided with recesses 42. These recesses 42 are advantageously constructed where no or only a little deformation of the support structure 30 is provided, i.e. for example in the upper shell 34 and the lower shell 36.

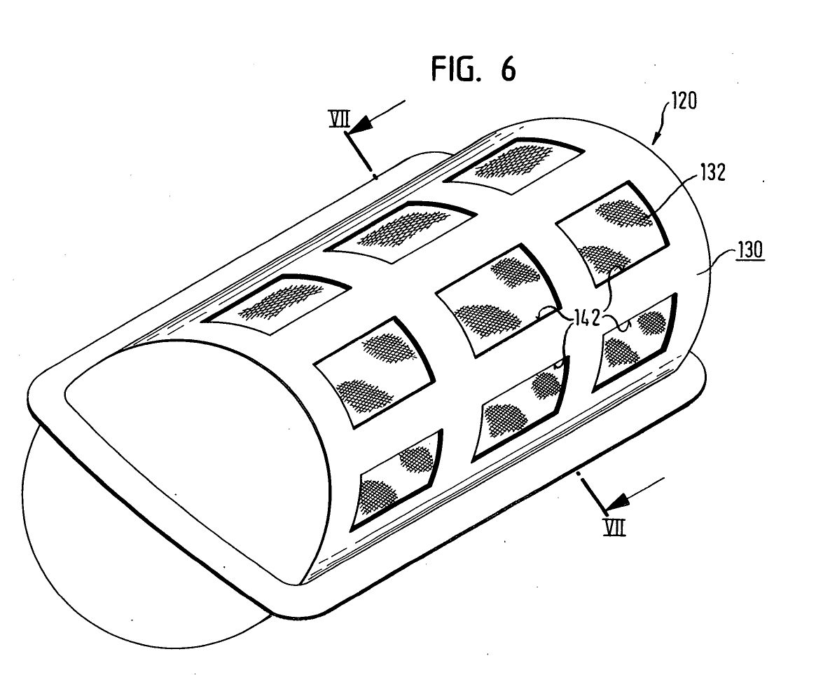

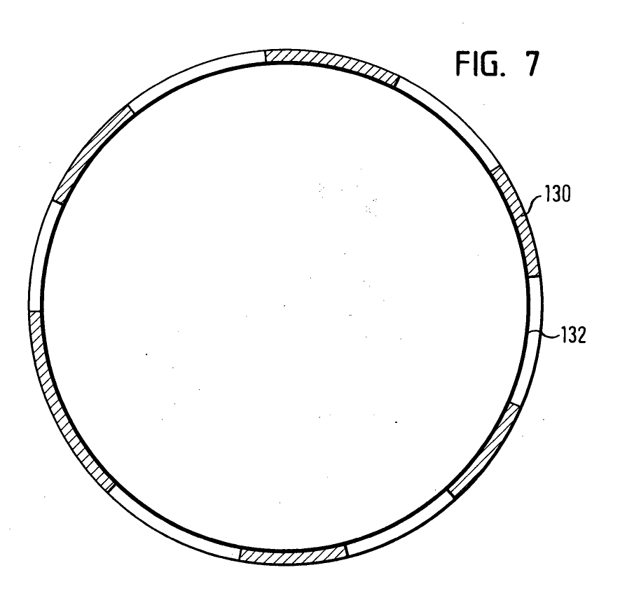

In FIGS. 6 and 7 a second embodiment can be seen, in the description of which reference numbers are used, increased by 100, for already known components.

In this embodiment, the support structure 130 is lined with a sealing casing 132 in the interior, which closes the recesses 142 and the open end faces in the support structure 130 in a gas-tight manner. The sealing casing can, for example, be a foil or a coated fabric, which is preferably glued internally onto the support structure 130.

According to an alternative construction, the sealing casing is not completely closed. It is sufficient if it closes the recesses 142 and the open end faces of the support structure 130 in a gas-tight manner.

In the described embodiments, the support structure 30 or 130 consists of a metal sheet. Of course, other plastically deformable materials such as polymer materials, fabrics or combinations of various materials also come into consideration for the formation of the support structure. The size and number of recesses is selected according to the desired rigidity of the support structure. Here, the support structure can also be constructed partially or totally in the form of a net.

Advantageously the seat restraint cushion 20 is connected with the seat frame 18 and/or is foamed into the seat pad 16.

1. An inflatable seat restraint cushion, with a plastically deformable support structure, a sealing casing is being provided which can be filled with gas from a compressed gas source in order to inflate said seat restraint cushion with deformation of said support structure.

2. The seat restraint cushion according to claim 1, characterized in that said sealing casing is formed by a gas bag.

3. The seat restraint cushion according to claim 1, characterized in that said support structure is tubular.

4. The seat restraint cushion according to claim 1, characterized in that said support structure has deformation elements which are plastically deformable.

5. The seat restraint cushion according to claim 4, characterized in that said deformation elements are folded in the non-inflated state of said seat restraint cushion.

6. The seat restraint cushion according to claim 1, characterized in that said support structure has recesses.

7. The seat restraint cushion according to claim 1, characterized in that said recesses are closed in a gas-tight manner by said sealing casing.

8. The seat restraint cushion according to claim 6, characterized in that said support structure is formed at least partially by a net structure.

9. A vehicle seat with a seat pad and having a seat restraint cushion according to claim 1.

10. The vehicle seat according to claim 9, characterized in that the seat restraint cushion is foamed into said seat pad.
